(19) United States
(12) Patent Application Publication
(10) Pub. No.: US 2017/0076703 A1
(43) Pub. Date: Mar. 16, 2017

(54) CYMBAL WASHER

(71) Applicant: YAMAHA CORPORATION, Hamamatsu-shi (JP)

(72) Inventor: Tomoya MIYATA, Hamamatsu-shi (JP)

(21) Appl. No.: 15/308,992

(22) PCT Filed: May 29, 2015
(86) PCT No.: PCT/JP2015/065682

§ 371 Date: Nov. 4, 2016

(30) Foreign Application Priority Data
Jun. 2, 2014 (JP) 2014-113786

(51) Int. Cl. G10D 13/06

(52) U.S. Cl. CPC G10D 13/06

(57) ABSTRACT

Provided is a cymbal washer with which the quality of cymbal sounds can be adjusted greatly without making a player perform a troublesome operation. The cymbal washer of the present invention is a washer for use in mounting a cymbal to a stand rod and is characterized by having a support portion that includes an elastic body which changes a contact area thereof with the cymbal according to the contact pressure on the cymbal. The support portion may have a protruding shape that protrudes toward the side of the surface facing the cymbal. The support portion may include notches at the periphery thereof. The support portion may have an anti-slip unit formed in a protruding shape on the surface facing the cymbal. The anti-slip unit may have a shape extending radially from the center of the support portion.

### TECHNICAL FIELD

The present invention relates to a cymbal washer with a sound quality adjustment function.

### BACKGROUND ART

A suspended cymbal set, which is a component of a drum set, is configured to mount one cymbal to a cymbal stand. A player plays music by striking this cymbal with a stick or a mallet. Here, if mounting a cymbal to a cymbal stand directly, since vibrations of the cymbal generated due to hitting are transmitted to the cymbal stand, hitting sound quality is deteriorated. Therefore, in order to solve this problem, a cymbal washer is used when mounting a cymbal to a cymbal stand.

The cymbal washer is a cylindrical elastic body made of felt or expanded urethane foam. A through-hole is provided at the center of the cymbal washer, and the cymbal washer is mounted to the cymbal stand by inserting a rod (support rod) of the cymbal stand to this through-hole. Normally, the cymbal is secured to the cymbal stand by being held by a pair of cymbal washers mounted to the cymbal stand. In this case, since the cymbal is mounted to the cymbal stand via the cymbal washers, vibrations of the cymbal are not transmitted easily to the cymbal stand and thus the deterioration of hitting sound quality is prevented. In addition, with such cymbal washers, it is possible to impart variation on hitting sound produced from the cymbal by changing pressure when holding the cymbal or a material of elastic bodies constituting the cymbal washers. Therefore, the cymbal washer is used not only as a support body but also as a means for sound quality adjustments.

FIG. 8 is a perspective view illustrating a cymbal washer disclosed in Non-Patent Document 1. Pairs of cymbal washers different in size are respectively configured by a double structure having a region made of foam (foamed rubber) and a region made of felt, as materials. FIGS. 8(a) to 8(d) illustrate examples in which a larger cymbal washer is disposed at the lower side and a smaller cymbal washer is disposed at the upper side. The cymbal is supported by the cymbal stand by being held by these two, upper and lower, cymbal washers. Here, regarding combinations of postures of the two, upper and lower, cymbal washers (i.e., regarding which region of either foam or felt faces the cymbal side), there are four kinds of combinations illustrated in FIGS. 8(a) to 8(d). In addition, although illustration is omitted, the larger cymbal washer may be disposed at the upper side and the smaller cymbal washer may be disposed at the lower side. Therefore, there are eight kinds of combinations of postures of the two, upper and lower, cymbal washers in all. The player can choose a desired combination among these eight kinds of combinations and can mount the cymbal to the cymbal stand with the combination of two cymbal washers which the player chose. In this case, it is possible to change quality of hitting sound produced from the cymbal depending on which combination the player chooses from among the eight kinds of combinations. Furthermore, it is still possible to change quality of hitting sound produced from the cymbal by adjusting a tightening degree of the cymbal washer and changing pressure when holding the cymbal.

In Patent Document 1, a pair of upper and lower felt washers attached to a rod holds a cymbal. Then, in Patent Document 1, a felt washer at the upper side is pressed from above by way of a clutch bolt used for tuning a drum, and this clutch bolt is secured to the rod by means of a tightening bolt.

Also in Patent Document 2, a pair of upper and lower felt washers attached to a rod holds a cymbal. Then, in Patent Document 2, a hemispherical sheet cup supports a felt at the lower side from below. In such a case, in a case of supporting the cymbal firmly being desired, a protruding portion of the sheet cup is directed to the lower side, and, in a case of freely moving the cymbal being desired such as a crash cymbal, the protruding portion of the sheet cup is directed to the upper side.

### PRIOR ART DOCUMENTS

### Patent Documents

Patent Document 1: Japanese Unexamined Utility Model Application, Publication No. H02-24897

Patent Document 2: U.S. Pat. No. 6,940,006

### Non-Patent Documents

Non-Patent Document 1: Foam/Felt Washer [Retrieved: Mar. 25, 2014] the Internet, <URL: http://www.pearlgakki.com/drum/pro_hd_cymbal.html>

### SUMMARY OF THE INVENTION

### Problems to be Solved by the Invention

According to the technology disclosed in Non-Patent Document 1 mentioned above, it is possible to adjust quality of hitting sound of the cymbal by adjusting a tightening degree of the washer to some extent. However, when the tightening degree exceeds a predetermined limit, felt, which is a material for the washer, is crushed, and the washer is no longer deformed even when increasing the tightening degree. Therefore, it is impossible to change the quality of hitting sound of the cymbal greatly only by adjusting the tightening degree of the washer. In order to change the quality of hitting sound of the cymbal greatly, it is necessary to change a combination of a posture of the two, upper and lower, washers. However, it is troublesome for a player to perform such a changing operation.

The same applies to the technology discloses in Patent Document 1 as well, and it is impossible to change the quality of hitting sound of the cymbal greatly only by adjusting the tightening degree of the washer.

In the technology disclosed in Patent Document 2, it is possible to choose a sway angle of the cymbal itself from two ways thereof by changing the direction of the sheet cup. However, it is also troublesome for a player to change the direction of the sheet cup. In addition, also in the technology disclosed in Patent Document 2, although it is possible to adjust the quality of hitting sound of the cymbal by adjusting the tightening degree of the washer, it is impossible to change the quality of hitting sound of the cymbal greatly only by adjusting the tightening degree of the washer.

The present invention was made in view of such circumstances described above and has an objective of providing a cymbal washer with which the quality of cymbal sounds can be adjusted greatly without making a player perform a troublesome operation.

### Means for Solving the Problems

The present invention provides a cymbal washer for use in mounting a cymbal to a stand rod, in which the cymbal washer includes a support portion that includes an elastic body which changes a contact area thereof with the cymbal according to contact pressure on the cymbal.

According to such a cymbal washer, the support portion changes the area of a contact surface with the cymbal according to a change of pressure applied to the contact surface with the cymbal. This change of the contact area changes vibrations of the cymbal when hitting the cymbal. Therefore, it is possible for a player to adjust quality of hitting sound of the cymbal by adjusting a tightening degree of the cymbal washer so as to change contact pressure applied to the cymbal of the support portion.

### BRIEF DESCRIPTION OF THE DRAWINGS

FIG. 1 is a side view illustrating a configuration of a cymbal set using a cymbal washer according to the first embodiment of the present invention;

FIG. 2 is a top view and a side view illustrating a configuration of a support portion in the first embodiment;

FIG. 3 is a side view illustrating an action of the support portion in the first embodiment;

FIG. 4 is a perspective view illustrating a configuration of a support portion of a cymbal washer according to the second embodiment of the present invention;

FIG. 5 is a perspective view illustrating an action of the support portion in the second embodiment;

FIG. 6 is a top view and a cross sectional view illustrating a configuration of a support portion of a cymbal washer according to the third embodiment of the present invention;

FIG. 7 is a top view and a cross sectional view illustrating a configuration of a support portion of a cymbal washer according to the fourth embodiment of the present invention; and

FIG. 8 is a perspective view illustrating a configuration of a conventional cymbal washer.

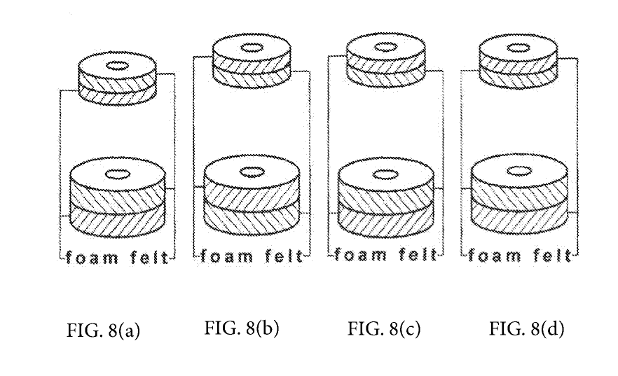

### DESCRIPTION OF EMBODIMENTS

Hereafter, embodiments of the present invention are described with reference to the drawings.

### First Embodiment

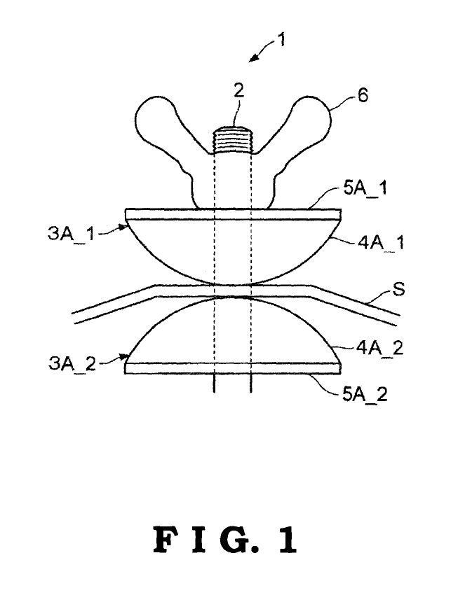

FIG. 1 is a cross sectional view illustrating a configuration of a cymbal set 1 using cymbal washers 3A_1 and 3A_2 which is the first embodiment of the present invention. As illustrated in FIG. 1, the cymbal set 1 is configured so that a rod 2 of a cymbal stand is inserted into the cymbal washer 3A_1, a cymbal S, the cymbal washer 3A_2, and a wing screw 6.

The rod 2 has a cylindrical shape and spiral screw threads which screw the wing screw 6 are formed at an outer peripheral surface of the upper portion thereof. In addition, a support leg (not illustrated) configured with a tripod, etc. is provided at the lower portion of the rod 2.

The cymbal washers 3A_1 and 3A_2 are configured by support portions 4A_1 and 4A_2 made of an elastic body as well as plates 5A_1 and 5A_2, respectively, and the cymbal S is held therebetween. The pair of the support portions 4A_1 and 4A_2 and the pair of the plates 5A_1 and 5A_2 are configured so as to have an identical shape with an identical material. For this reason, the pair of the support portions 3A_1 and 3A_2 is collectively referred to as a cymbal washer 3A if it is unnecessary to distinguish the cymbal washer 3A_1 from the cymbal washer 3A_2, and the pair of the support portions 4A_1 and 4A_2 is collectively referred to as a support portion 4A if it is unnecessary to distinguish the support portion 4A_1 from the support portion 4A_2.

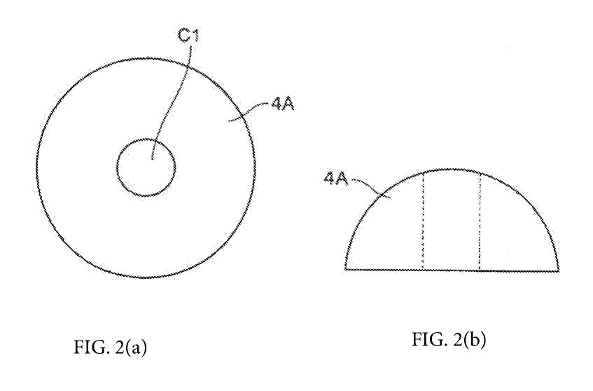

FIGS. 2(a) and (b) are respectively a top view and a side view illustrating a configuration of the support portion 4A in the first embodiment. In the support portion 4A, the elastic body is formed in a hemispherical shape. In other words, the support portion 4A has a protruding shape which protrudes toward the side of the surface facing the cymbal. In the support portion 4A, a through-hole C1 into which the rod 2 is inserted is provided vertically from an apex of the hemispherical support portion to a bottom surface thereof. The diameter of the bottom surface of this hemisphere is 35 mm. In the present embodiment, expanded urethane foam is used for the elastic body as a material of the support portion 4A. This expanded urethane foam is a material having appropriate repulsion force and restoring force. Due to this, the support portion 4A changes in its shape flexibly when pressed externally and restores its original shape when the pressing is released.

In FIG. 1, the plates 5A_1 and 5A_2 have the same shape as that of the bottom surface of the support portion 4A (i.e., a circular shape), and a through-hole into which the rod 2 is inserted is provided at the center portion. The plates 5A_1 and 5A_2 are made of a material having rigidity such as an iron plate or a plastic plate. The lower plate 5A_2 is fixed to the rod 2 to support the bottom surface of the support portion 4A_2 from below. The upper plate 5A_1 is supported by the rod 2 in a slidable manner and placed on the bottom surface of the support portion 4A_1.

The wing screw 6 is provided at the upper portion of the plate 5A_1 and screwed on a male screw thread of the rod 2. The wing screw 6 moves downward when rotating clockwise and moves upward when rotating counter-clockwise. The wing screw 6 adjusts a tightening degree of the cymbal washers 3A_1 and 3A_2.

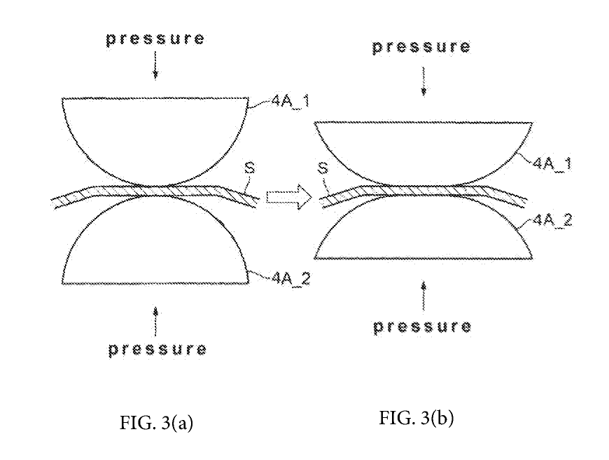

FIGS. 3(a) and 3(b) are side views illustrating a state in which the shapes of the support portions 4A_1 and 4A_2 change when the tightening degree of the support portions 4A_1 and 4A_2 is changed by the wing screw 6.

FIG. 3(a) exemplifies the shapes of the support portions 4A_1 and 4A_2 in a case of the tightening degree being small. In this case, since contact pressure of the support portions 4A_1 and 4A_2 on the cymbal S is low, the contact area of the support portions 4A_1 and 4A_2 with the cymbal S is small.

Here, as the tightening degree of the support portions 4A_1 and 4A_2 increases by rotating the wing screw 6 clockwise, the shapes of the support portions 4A_1 and 4A_2 are elastically deformed greatly as exemplified in FIG. 3(b). In such a case, since the contact pressure of the support portions 4A_1 and 4A_2 on the cymbal S becomes high, the contact area of the support portions 4A_1 and 4A_2 with cymbal S increases. Due to this, quality of hitting sound of the cymbal S changes greatly.

More specifically, since the attenuation amount of vibrations of the cymbal S generated when hitting the cymbal S becomes great as the contact area of the support portions 4A_1 and 4A_2 with the cymbal S increases, it is possible to achieve prompt convergence of the sound.

Then, as the tightening degree of the support portions 4A_1 and 4A_2 decreases by rotating the wing screw 6 counter-clockwise, the shape of the support portions 4A_1 and 4A_2 returns to the shape exemplified in FIG. 3(a), for example. With such a configuration, the contact pressure of the support portions 4A_1 and 4A_2 with the cymbal S becomes low again and the quality of hitting sound of the cymbal S returns to its original sound quality.

As described above, according to the present embodiment, it is possible to change the quality of hitting sound of the cymbal S greatly by changing the tightening degree of the cymbal washers 3A_1 and 3A_2 by means of the rotation of the wing screw 6 so as to change the contact area of the support portions 4A_1 and 4A_2 with the cymbal S. Therefore, according to the present embodiment, it is possible to adjust the quality of hitting sound of the cymbal S without performing a troublesome operation such as replacement of a cymbal washer.

Furthermore, in the present embodiment, if making a curvature of the spherical surface of the support portion 4A smaller, it is possible to make a range of a change of the contact area with the cymbal S with respect to a change of the tightening degree of the support portions 4A_1 and 4A_2 smaller. On the other hand, if making a curvature of the spherical surface of the support portion 4A larger, it is possible to make the range of the change of the contact area with the cymbal S with respect to the change of the tightening degree of the support portions 4A_1 and 4A_2 larger. Therefore, it is possible to perform dynamic adjustment for quality of hitting sound by adjusting the curvature of the spherical surface of the support portion 4A appropriately. Accordingly, it is possible to optimize the range of the change of the quality of hitting sound of the cymbal S with respect to the change of the tightening degree of the cymbal washers 3A_1 and 3A_2 by choosing a curvature of the spherical surface of the support portion 4A appropriately.

Furthermore, according to the present embodiment, since the support portion 4A is made of expanded urethane foam, the support portion 4A does not collapse even if performing strong tightening repeatedly. Therefore, according to the present embodiment, it is possible to extend the life of the cymbal washer 3A as compared with the life of a cymbal washer using a conventional felt.

The lower limit of the compression modulus (Young's modulus) of the support portion 4A is preferably 0.01 MPa, more preferably 0.05 MPa, and more preferably 0.2 MPa. Furthermore, the upper limit of the compression modulus of the support portion 4A is preferably 25 MPa, more preferably 5 MPa, and more preferably 2 MPa. When the lower limit of the compression modulus of the support portion 4A falls below the lower limit, the support portion 4A may be easily deformed. For this reason, it may become difficult to control the contact area of the support portion 4A with the cymbal S and thus it may become difficult to adjust the quality of hitting sound of cymbal S. On the other hand, when the upper limit of the compression modulus of the support portion 4A exceeds the upper limit, the support portion 4A may be hardly deformed. Due to this, the contact area with the cymbal S may hardly change and thus it may become impossible to perform dynamic adjustment for quality of hitting sound of the cymbal S.

Materials having a compression modulus of no less than 0.01 MPa and less than 0.2 MPa include felt, non-woven fabric, and sponge, for example. Materials having a compression modulus of no less than 0.2 MPa and no greater than 2 MPa include expanded urethane foam, for example. Materials having a compression modulus of more than 2 MPa and no greater than 25 MPa include resin with no bubbles, for example. Although these compression moduli can be adjusted appropriately, the support portion 4A formed of expanded urethane foam containing independent air bubbles is preferable since a contact area can be easily adjusted even when contact pressure is high.

The above-described compression modulus can be measured by means of a 25% compression test (at room temperature) according to JIS-K-6254(2010). In addition, in a case of producing a longer reverberant sound of a cymbal being desired, it is preferable to set a higher repulsion coefficient of the support portion 4A. More specifically, it is preferable that the tan δ of a material forming the support portion 4A is no greater than 0.1. On the other hand, in a case of producing a shorter reverberant sound being desired, it is preferable that the tan δ exceeds 0.1. Although these tans δ can be adjusted appropriately, it is particularly preferable to form the support portion 4A by adjusting the tan δ so as to be no greater than 0.1 in the above-described expanded urethane foam for the purpose of sounding a reverberant sound of the cymbal well. It should be noted that the tan δ is a value measured according to JIS-K-6394(2007).

### Second Embodiment

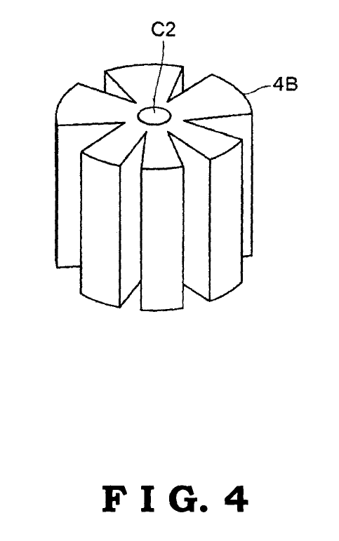

FIG. 4 is a perspective view illustrating a configuration of a support portion 4B of a cymbal washer which is the second embodiment of the present invention. The support portion 4B includes a plurality of notches which are provided at the outer periphery toward the center and has a planar shape in which a plurality of petal portions 4B1 are formed radially. In addition, a through-hole C2 which a rod 2 penetrates is provided from an upper surface to a lower surface at the support portion 4B. Herein, a vertical axis directing from the upper surface to the lower surface through the center of the through-hole C2 is referred to as a central axis of the support portion 4B. In the present embodiment, the notches provided at the support portion 4B are configured such that the widths gradually become narrower as going from the outer peripheral surface to the central axis of the support portion 4B. It should be noted that the shape of the support portion 4B is not limited thereto and may be modified appropriately. Similarly to the support portion 4A according to the above-described first embodiment, the support portion 4B is made of expanded urethane foam. For this reason, the support portion 4B is freely deformed by pressure applied externally.

Similarly to the above-described first embodiment, also in the present embodiment, a cymbal is fixed to a rod by two support portions 4B holding the cymbal S from above and below (refer to FIG. 1). In addition, similarly to the above-described first embodiment, also in the present embodiment, it is possible to adjust tightening degrees of the two support portions 4B by means of an operation to rotate a wing screw 6.

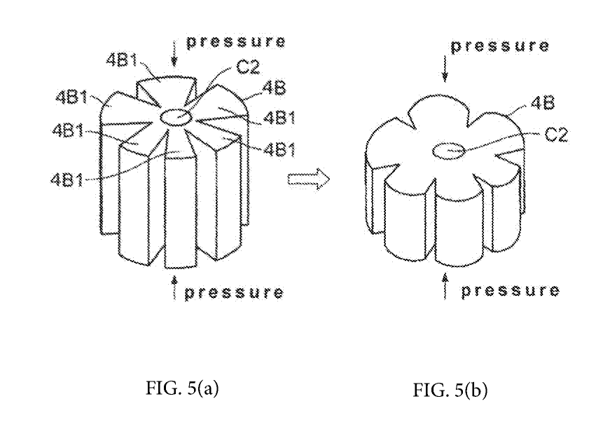

FIG. 5(a) exemplifies a shape of the support portion 4B in a case of the tightening degree being small. FIG. 5(b) exemplifies a shape of the support portion 4B in a case of the tightening degree being large. As illustrated in FIG. 5(b), as the tightening degree becomes large and contact pressure of the support portion 4B on the cymbal S increases, the plurality of petal portions 4B1 of the support portion 4B are elastically deformed to stretch out in a circumferential direction of the support portion 4B and thus a contact area of the support portion 4B with the cymbal S increases. Therefore, similar effects to the above-described first embodiment can be obtained also in the present embodiment.

### Third Embodiment

In the above-described first embodiment, if pressure of holding by the cymbal washers 3A_1 and 3A_2 is low, the cymbal S may rotate due to an impact when hit by a stick. Given this, in the present embodiment, an anti-slip unit for preventing the cymbal S from rotating is provided at a support portion of a cymbal washer.

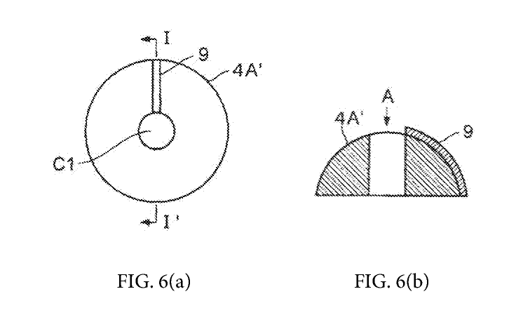

FIGS. 6(a) and 6(b) are views illustrating configuration examples of a support portion 4A′ of a cymbal washer according to the present embodiment. Here, FIG. 6(a) is a top view when seeing the support portion 4A′ of FIG. 6(b) in the direction shown as an arrow A and FIG. 6(b) is a cross sectional view along a line I-I′ of FIG. 6(a). As illustrated in FIG. 6(a), one anti-slip unit 9 is provided which is formed from the vicinity of the through-hole Cl toward an outer periphery of the support portion 4A′ on a spherical surface of the support portion 4A′. In addition, as illustrated in FIG. 6(b), the anti-slip unit 9 has a protruding shape that protrudes toward a surface facing the cymbal toward the cymbal side. It should be noted that a cross sectional shape perpendicular to an axis of the anti-slip unit 9 may be chosen appropriately such as a semicircle and a polyhedral shape.

According to the present embodiment, frictional force is generated between the cymbal S and the anti-slip unit 9. Due to this frictional force, it is possible to inhibit rotational motion of the cymbal S. Furthermore, since the anti-slip unit 9 extends from the central axis of the support portion 4A′ toward the outer periphery, it is possible to exert the frictional force on a broader range of the cymbal S. Therefore, the support portion 4A′ can inhibit the rotational motion of the cymbal efficiently.

### Fourth Embodiment

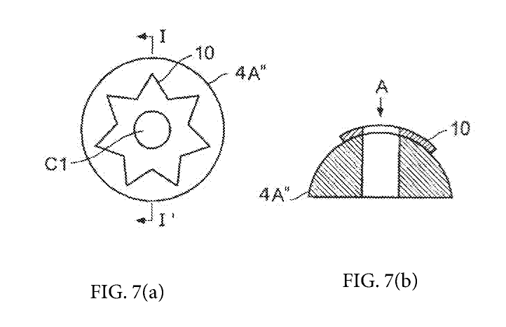

The present embodiment is a modified embodiment of the above-described third embodiment. FIGS. 7(a) and 7(b) are views illustrating configuration examples of a support portion 4A″ of a cymbal washer according to the present embodiment. Here, FIG. 7(a) is a top view when seeing the support portion 4A″ of FIG. 7(b) in the direction shown as an arrow A and FIG. 7(b) is a cross sectional view along a line I-I′ of FIG. 7(a). As illustrated in FIG. 7(a), an anti-slip unit 10 is provided which extends radially from the vicinity of the through-hole C1 toward the outer periphery of the support portion 4A″ on a spherical surface of the support portion 4A″ (a surface facing the cymbal S). In addition, as illustrated in FIG. 7(b), the anti-slip unit 10 has a protruding shape that protrudes toward a surface facing the cymbal S. It should be noted that a planar shape of the anti-slip unit 10 may be chosen appropriately such as a semicircle and a polyhedral shape.

Also according to the present embodiment, frictional force is generated between the cymbal S and the anti-slip unit 10. Due to this frictional force, it is possible to inhibit rotational motion of the cymbal S. Furthermore, the anti-slip unit 10 extends radially from the central axis of the support portion 4A″ toward the outer periphery. Therefore, it is possible to inhibit rotational motion of a cymbal more efficiently than the above-described third embodiment. Furthermore, when the anti-slip unit 10 of the present embodiment is brought into contact with the cymbal S, the anti-slip unit 10 imparts variation on hitting sound produced from the cymbal S. Therefore, according to the present embodiment, it is possible to perform tuning of the hitting sound by means of the support portion 4A″.

### Other Embodiments

Although various kinds of embodiments of the present invention are described above, other embodiments of the present invention still can be contemplated. Such embodiments are as follows.

(1) Although the support portion 4A has a hemispherical shape in the above-described first embodiment, the shape is not limited thereto and thus may be conical or an assembly of a plurality of hemispheres, for example. Furthermore, a support portion may be configured to be in a spherical shape or a spherical support portion may be configured by joining planar portions of two hemispherical support portions. Since it is possible to change the contact area with the cymbal S according to pressure applied to an elastic body even in such a shape, an effect similar to the elastic body having a hemispherical surface can be obtained. Furthermore, such a spherical support portion is elastically deformed at a contact surface between the support portion and a wing screw 6 when rotating the wing screw 6. Therefore, since it is possible to change the contact area with cymbal S finely with this spherical support portion, it is possible to finely adjust the quality of hitting sound of the cymbal S.

(2) Although the pair of cymbal washers in each of the above-described embodiments is configured by cymbal washers of the same kind, it may be configured so that one cymbal washer is different from the other cymbal washer in kind. For example, it may be configured so that the one is a cymbal washer 3A having the support portion 4A and the other is a felt cymbal washer which is used conventionally.

(3) Although the support portion is made of expanded urethane foam in each of the above-described embodiments, a material for the support portion is not limited thereto. In other words, a material can be accepted as a material for the support portion so long as it is a flexible elastic body that can change a contact area with a cymbal according to a change of pressure applied to a contact surface with the cymbal.

(4) The mounting of the plate 5A_1 which presses the support portion from above may be omitted in each of the above-described embodiments. In other words, it is unnecessary to mount the plate 5A_1 in a case in which the support portion possesses certain rigidity and deformation of a bottom surface due to being pressed is small.

(5) The cymbal washers in each of the above-described embodiments may be used for a high-hat cymbal. In such a case, since the optimal value of the tightening degree of a cymbal differs from the optimal value for the case of mounting a single cymbal, it is necessary to adjust the optimal value appropriately.

(6) The anti-slip units 9 and 10 described in the third embodiment and the fourth embodiment may be provided at the support portion 4B of the cymbal washer of the second embodiment.

### EXPLANATION OF THE REFERENCE SYMBOLS

1 Cymbal set
2 Rod
3A, 3A_1, 3A_2 Cymbal washer
4A, 4A_1, 4A_2, 4A′, 4A″ Support portion
5A_1, 5A_2 Plate
6 Wing screw
4B_1 Petal portion
9, 10 Anti-slip unit
C1, C2 Through-hole
S Cymbal

1. A cymbal washer for use in mounting a cymbal to a stand rod, the cymbal washer comprising:
a support portion that comprises an elastic body which changes a contact area thereof with the cymbal according to contact pressure on the cymbal.

2. The cymbal washer according to claim 1, wherein the support portion has a protruding shape that protrudes toward a side of a surface facing the cymbal.

3. The cymbal washer according to claim 1, wherein the support portion comprises notches at a periphery thereof.

4. The cymbal washer according to claim 1, wherein the support portion has an anti-slip unit formed in a protruding shape on the surface facing the cymbal.

5. The cymbal washer according to claim 4, wherein the anti-slip unit has a shape extending radially from a center of the support portion.

6. The cymbal washer according to claim 1, further comprising a plate in contact with a bottom surface of the support portion on an opposite side of a surface facing the cymbal, wherein the plate has a same shape as a shape of the bottom surface of the support portion.
